(19) United States
(12) Patent Application Publication
(10) Pub. No.: US 2015/0130845 A1
(43) Pub. Date: May 14, 2015

(54) OUT-OF-VIEWPOINT INDICATORS FOR RELEVANT MAP FEATURES

(71) Applicants: Daniel Otero, Seattle, WA (US); Jonah Jones, San Francisco, CA (US)

(72) Inventors: Daniel Otero, Seattle, WA (US); Jonah Jones, San Francisco, CA (US)

(73) Assignee: GOOGLE INC., Mountain View, CA (US)

(21) Appl. No.: 13/586,694

(22) Filed: Aug. 15, 2012

(51) Int. Cl. G06F 3/048; G06T 3/40; G06K 9/00

(52) U.S. Cl. CPC G06T 3/40; G06K 9/00476
USPC 345/661; 715/781

(57) ABSTRACT

A graphics or image rendering system, such as a map image rendering system, renders an indicator of an out-of-view map feature that is generated based on a user context, including a selection of a map feature or a search for a set of map features.

### FIELD OF TECHNOLOGY

The present disclosure relates to map rendering systems, such as electronic map display systems, and more specifically to a map rendering system that renders a set of indicators for out-of-view map features.

### BACKGROUND

While digital maps may be commonly implemented in a wide variety of devices (e.g., mobile phones, car navigation systems, hand-held global positioning system (GPS) units, computers, and many websites), methods of displaying digital maps remain challenging due to limitations in display device screen sizes and resolutions. Unlike paper maps in which a user may unfold the entirety of a map and view any portion of the map at leisure, a map rendering system may only display a small portion of a map surface at a time. Moreover, the size of the portion that may be displayed may limited by a desired viewing resolution or viewing magnification of the map image being rendered.

Because only a portion of a map surface may be viewed at one time, some map features may not be contained in a current viewing window or viewport of a map surface at a user-selected level of detail or magnification. However, out-of-view map features that are external to a current viewing window or out-of-view (also referred to herein as “OOV”) may be important enough that a user may desire information on the OOV map features.

### SUMMARY

A computer-implemented method for rendering a map on a display device includes determining a first viewing window of a map surface, the first viewing window defined by a set of viewing parameters including a position, a set of viewing boundaries, and a magnification. The method displays a first area of the map surface in the first viewing window based on the set of viewing parameters. The method receives a user context associated with at least one of a user selected map feature or a search request for a set of map features. The method generates an out-of-view indicator of an out-of-view map feature based on the received user context, wherein the out-of-view map feature is external to the displayed first area of the map surface. The method displays the out-of-view indicator within the first viewing window. The displayed out-of-view indicator includes a directional indicator and includes a second viewing window of a second area of the map surface that contains the out-of-view map feature, wherein the first area and the second area are not contiguous.

### BRIEF DESCRIPTION OF THE DRAWINGS

FIG. 1 is a high-level block diagram of a map imaging system that implements communications between a map database stored in a server and one or more map image rendering devices, according to an embodiment.

FIG. 2 is a high level block diagram of an image rendering engine used to render map images using map vector data, according to an embodiment.

FIG. 3A is a data diagram illustrating a set of vector data in the form of vertex data points encoded using a vertex style attribute.

FIG. 3B is a first texture map in the form of a style lookup table that defines vertex style attribute values for each of a number of different styles and which is used in the image rendering engine of FIG. 2 to resolve vertex style attributes based on a style reference, according to an embodiment.

FIG. 4 illustrates a process flow diagram or flow chart of a method, routine, or process 400 that may be used to render a map surface with out-of-view indictors.

FIG. 5 illustrates a primary viewing window of a first map area.

FIG. 6 illustrates a basic out-of-view indicator.

FIG. 7 illustrates a viewing window of the map area of FIG. 5 that includes an OOV map indicator.

FIG. 8 illustrates a map surface area showing a first area rendered by a primary viewing window and a second area outside the first area containing an out-of-view map feature.

FIG. 9 illustrates a primary viewing window with a designated OOV indicator area.

FIG. 10 illustrates an OOV for a partially in-view map feature.

FIG. 11 illustrates a data diagram of an association between two or more map features.

FIG. 12 illustrates a process flow diagram or flow chart of a method, routine, or process that may be used to render an out-of-view indictor with operational functionality, according to an embodiment.

### DETAILED DESCRIPTION

The current application generally relates to techniques for providing information on a set of map features that is not contained within a viewable portion of a map surface that is currently displayed within a viewing window. An external map feature may be referred to herein as an out-of-view (referred to herein as “OOV”) map feature or out-of-viewport map feature. When an out-of-view map feature is determined to be important to a user or is determined to be of high priority, an out-of-view (OOV) indicator may be generated and displayed within the primary viewing window to display information to a user about the OOV map feature.

Map features that are external to a current viewing window may be important for many reasons. In one situation, a first map feature may have a relation or association to a second map feature (e.g., an OOV map feature) that is important to a user. For example, a current viewing window may represent an area about an origin of a user's route, where an out-of-view map feature may be a possible destination of interest. The user may be interested in plotting a route from the origin contained in the current viewing window to an OOV destination. In this situation, the user may require details of a map feature in the current viewing window as well as some general information about a second location/area that is not contained in the map area of a primary or current viewing window. Because the route may not fit into a current viewing window at a particular magnification, an OOV indicator may be displayed (e.g., along a displayed portion of the route) to indicate a continuation of the route off screen.

In another situation, a user may indicate an interest in an in-view map feature (e.g., via a mouse click of or a mouse hover-over through the map feature). The indication of interest may correspond to a possibility that the user may require information on an out-of-view map feature that is related or otherwise relevant to the in-view map feature. In this case, an OOV indicator may provide some high level detail about an OOV map feature that is related to the in-view map feature. In an another situation, the OOV map feature may be important to a user context involving a search, where the search results may indicate points of interest that are not in the user current viewing window. The above examples illustrate only some of the many situations in which an OOV indicator of an OOV map feature may be important or useful to a user.

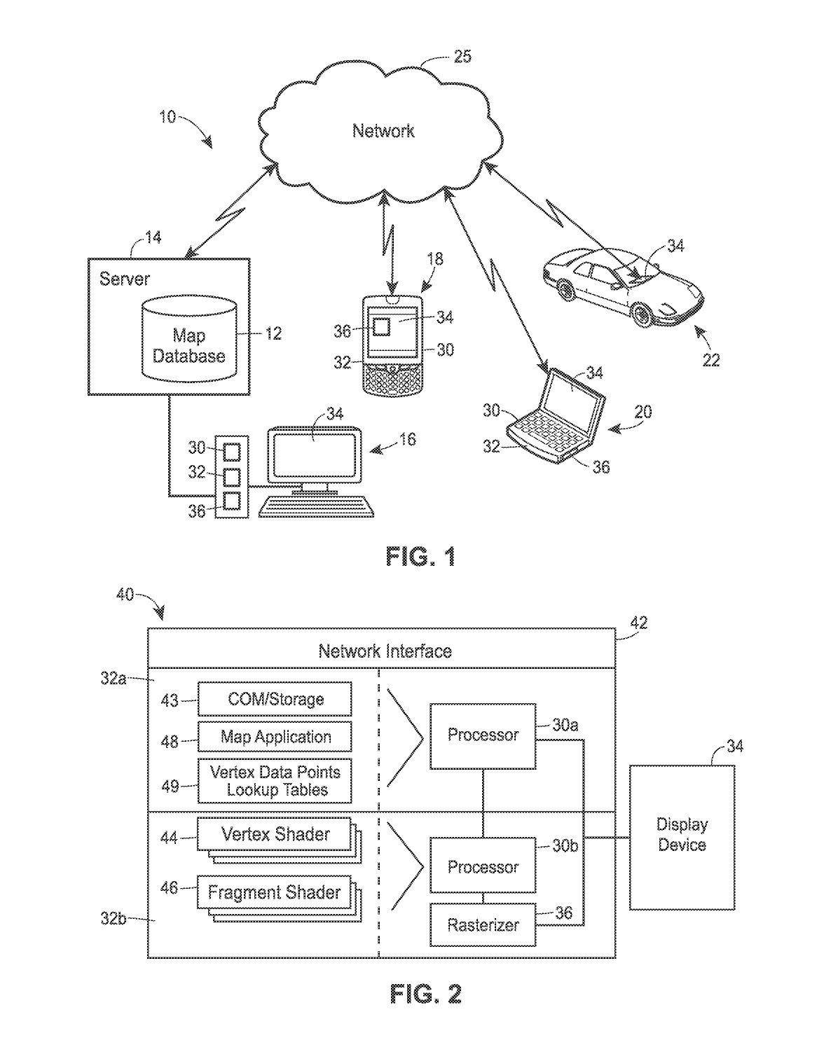

Referring now to FIG. 1, a map-related imaging system 10, according to an embodiment, includes a map database 12 stored in a server 14 or in multiple servers located at, for example, a central site or at various different spaced apart sites, and also includes multiple map client devices 16, 18, 20, and 22, each of which stores and implements a map rendering device or a map rendering engine. The map client devices 16-22 may be connected to the server 14 via any hardwired or wireless communication network 25, including for example a hardwired or wireless local area network (LAN), metropolitan area network (MAN) or wide area network (WAN), the Internet, or any combination thereof. The map client devices 16-22 may be, for example, mobile phone devices (18), computers such a laptop, tablet, desktop or other suitable types of computers (16, 20) or components of other imaging systems such components of automobile navigation systems (22), etc. Moreover, the client devices 16-22 may be communicatively connected to the server 14 via any suitable communication system, such as any publically available and/or privately owned communication network, including those that use hardwired based communication structure, such as telephone and cable hardware, and/or wireless communication structure, such as wireless communication networks, including for example, wireless LANs and WANs, satellite and cellular phone communication systems, etc.

The map database 12 may store any desired types or kinds of map data including raster image map data and vector image map data. However, the image rendering systems described herein are best suited for use with vector image data which defines or includes a series of vertices or vertex data points for each of numerous sets of image objects, elements or primitives within an image to be displayed. Generally speaking, each of the image objects defined by the vector data will have a plurality of vertices associated therewith and these vertices will be used to display a map related image object to a user via one or more of the client devices 16-22. As will also be understood, each of the client devices 16-22 includes an image rendering engine having one or more processors 30, one or more memories 32, a display device 34, and in many cases a rasterizer or graphics card 36 which are generally programmed and interconnected in known manners to implement or to render graphics (images) on the associated display device 34. The display device 34 for any particular client device 16-22 may be any type of electronic display device such as a liquid crystal display (LCD), a light emitting diode (LED) display, a plasma display, a cathode ray tube (CRT) display, or any other type of known or suitable electronic display.

Generally, speaking, the map-related imaging system 10 of FIG. 1 operates such that a user, at one of the client devices 16-22, opens or executes a map application (not shown in FIG. 1) that operates to communicate with and obtain map information or map related data from the map database 12 via the server 14, and that then displays or renders a map image based on the received map data. The map application may allow the user to view different geographical portions of the map data stored in the map database 12, to zoom in or zoom out on a particular geographical location, to rotate, spin or change the two-dimensional or three-dimensional viewing angle of the map being displayed, etc. More particularly, when rendering a map image on a display device or a display screen 34 using the system described below, each of the client devices 16-22 downloads map data in the form of vector data from the map database 12 and processes that vector data using one or more image shaders to render an image on the associated display device 34.

Referring now to FIG. 2, an image generation or imaging rendering device 40, according to an embodiment, associated with or implemented by one of the client devices 16-22 is illustrated in more detail. The image rendering system 40 of FIG. 2 includes two processors 30a and 30b, two memories 32a and 32b, a user interface 34 and a rasterizer 36. In this case, the processor 30b, the memory 32b and the rasterizer 36 are disposed on a separate graphics card (denoted below the horizontal line), although this need not be the case in all embodiments. For example, in other embodiments, a single processor may be used instead. In addition, the image rendering system 40 includes a network interface 42, a communications and storage routine 43 and one more map applications 48 having map display logic therein stored on the memory 32a, which may be executed on the processor 30a (e.g., which may be a central processing unit (CPU)). Likewise one or more image shaders in the form of, for example, vertex shaders 44 and fragment shaders 46 are stored on the memory 32b and are executed on the processor 30b. The memories 32a and 32b may include either or both volatile and non-volatile memory and the routines and shaders are executed on the processors 30a and 30b to provide the functionality described below. The network interface 42 includes any well known software and/or hardware components that operate to communicate with, for example, the server 14 of FIG. 1 via a hardwired or wireless communications network to obtain image data in the form of vector data for use in creating an image display on the user interface or display device 34. The image rendering device 40 also includes a data memory 49, which may be a buffer or volatile memory for example, that stores vector data received from the map database 12, the vector data including any number of vertex data points and one or more lookup tables as will be described in more detail.

During operation, the map logic of the map application 48 executes on the processor 30 to determine the particular image data needed for display to a user via the display device 34 using, for example, user input, GPS signals, prestored logic or programming, etc. The display or map logic of the application 48 interacts with the map database 12, using the communications routine 43, by communicating with the server 14 through the network interface 42 to obtain map data, preferably in the form of vector data or compressed vector data from the map database 12. This vector data is returned via the network interface 42 and may be decompressed and stored in the data memory 49 by the routine 43. In particular, the data downloaded from the map database 12 may be a compact, structured, or otherwise optimized version of the ultimate vector data to be used, and the map application 48 may operate to transform the downloaded vector data into specific vertex data points using the processor 30a. In one embodiment, the image data sent from the server 14 includes vector data generally defining data for each of a set of vertices associated with a number of different image elements or image objects to be displayed on the screen 34 and possibly one or more lookup tables which will be described in more detail below. If desired, the lookup tables may be sent in, or may be decoded to be in, or may be generated by the map application 48 to be in the form of vector texture maps which are known types of data files typically defining a particular texture or color field (pixel values) to be displayed as part of an image created using vector graphics. More particularly, the vector data for each image element or image object may include multiple vertices associated with one or more triangles making up the particular element or object of an image. Each such triangle includes three vertices (defined by vertex data points) and each vertex data point has vertex data associated therewith. In one embodiment, each vertex data point includes vertex location data defining a two-dimensional or a three-dimensional position or location of the vertex in a reference or virtual space, as well as an attribute reference. Each vertex data point may additionally include other information, such as an object type identifier that identifies the type of image object with which the vertex data point is associated. The attribute reference, referred to herein as a style reference or as a feature reference, references or points to a location or a set of locations in one or more of the lookup tables downloaded and stored in the data memory 43.

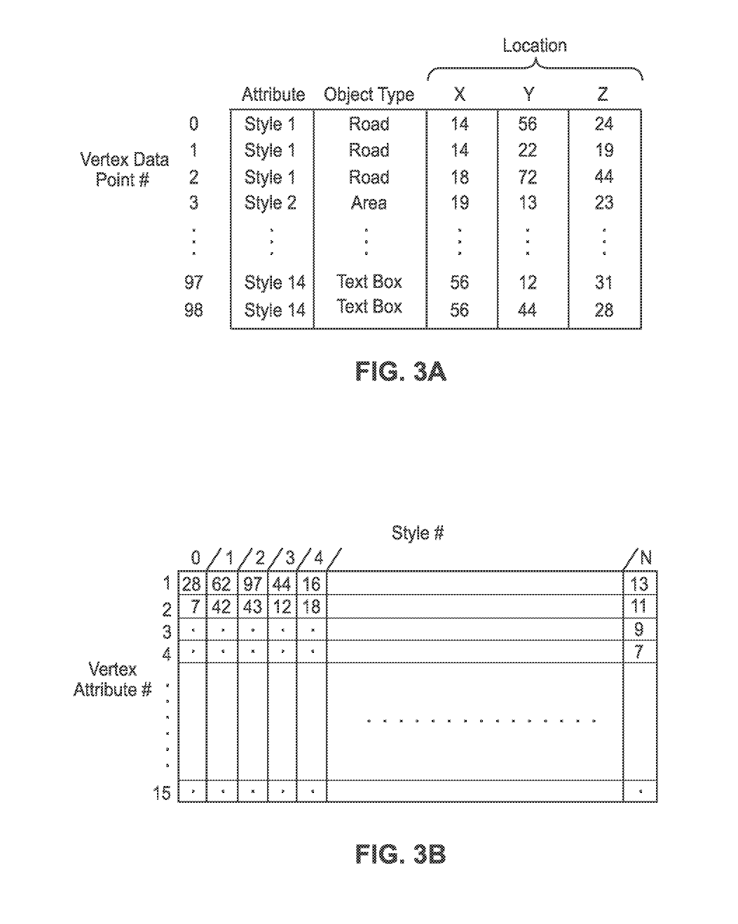

FIG. 3A illustrates an embodiment of map data that may be sent to a client device, such as device 40 of FIG. 2, for processing, according to an embodiment. As FIG. 3A illustrates, map data contains location data for a vertex, an object type, and a style attribute(s) for the vertex. A set of one or more of the vertices may comprise an image object or feature of a map, such as a road or building. The style attributes may be sent for each vertex or may reference a style look up table such as that illustrate in FIG. 3B that can be used to decode a style reference from FIG. 3A into a complete set of one or more style attribute parameters values, according to an embodiment.

Style parameters may include a fill color (e.g., for area objects), an outline color, an outline width, an outline dashing pattern and an indication of whether to use rounded end caps (e.g., for road objects), an interior color, an interior width, an interior dashing pattern, and interior rounded end caps (e.g., for road objects), a text color and a text outline color (e.g., for text objects), an arrow color, an arrow width, an arrow dashing pattern (e.g., for arrow objects), a text box fill color and a set of text box outline properties (e.g., for text box objects) to name but a few. Of course, different ones of the vertex style attributes provided may be applicable or relevant to only a subset of image objects and thus the vertex style data points associated with a particular type of image object may only refer to a subset of the vertex attributes listed for each style.

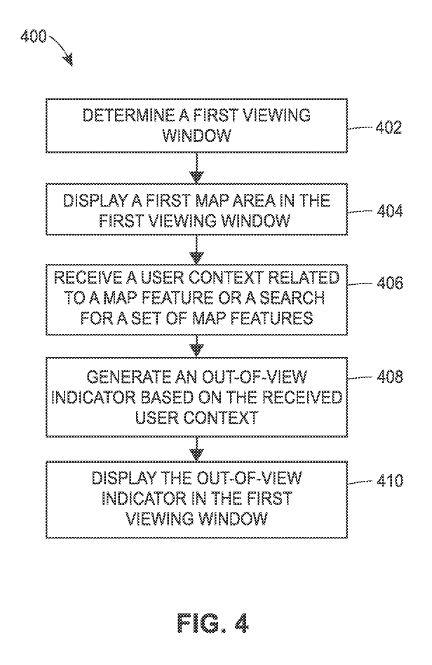

FIG. 4 illustrates a process flow diagram or flow chart of a method, routine, or process 400 that may be used to render a map surface with out-of-view indictors, according to an embodiment. In any event, a block 402 may determine a first viewing window defined by a set of parameters including at least a position, a size or a set of boundaries, and a zoom level. A block 404 may display a first map area in the first viewing window based on the viewing window parameters. A block 406 may receive a user context related to a map feature or a search for a set of map features. A block 408 may generate an out-of-view indicator based on the received user context. A block 410 may display the out-of-view indicator on the first viewing window.

The block 402 may determine a viewing window by at least a position, a size, and a zoom level of the viewing window. In three-dimensional map renderings, the viewing window may be further defined by a direction of view as well as a tilt angle (or angle of incidence of the viewing window with a map surface plane). The position of the viewing window may be a position of the viewing window with respect to a portion of a map surface (to be displayed). While any portion of the viewing window may relate to a position on a map surface, the center position of the viewing window may be used as a reference point herein when describing the position of the viewing window. For example, a center position of the viewing window may relate to or correspond with a point or area of a map surface that is or will be displayed on the viewing window. In this case, the center of the viewing window may correspond to a center of the displayed first map area.

The size of the viewing window may be defined by a physical set of dimensions of a display device or display screen. In some embodiments, a viewing window may only represent a portion of a total display screen. For example, a mapping application or other application (e.g., a computer operating system) may allocate only a portion of a total display screen for use as a viewing window of a digital map. Generally, a viewing window size may be denoted using pixel-based dimensions. For example, in a rectangular viewing window, the size of the viewing window may be defined by a length and width measurement such as 640×480 pixels. Instead of pixel lengths, the viewing window may also be defined in a common distance metric such as millimeters or inches. The viewing window size may also correspond to a set of boundaries of a displayed portion of a map surface. In a rectangular viewing window embodiment, the size of the viewing window may be defined by two 640 pixel borders and two 480 pixel borders, wherein the pixel lengths of the borders may be equivalent to distances of the displayed first map area depending on a scaling factor or magnification (to be discussed further below). Accordingly, the viewing window size may be described by the portion of a map surface that is displayed and defined by the set of viewing window boundaries.

A zoom level corresponds, in part, to a magnification which is used, in part, to define a displayable area of a map surface within a viewing window. A magnification of the viewing window may correspond with a scale for which the map surface is rendered or drawn. For example, where magnification or scale is expressed as a ratio such as 1:1000, one of any unit of measurement on the viewing window (e.g., pixel length) may correspond exactly or approximately to 1,000 actual units (e.g., miles or kilometers) of a map surface. In particular, when the viewing window size is measured in inches, the distance scale may translate an inch of the viewing window to a length of 1,000 miles (or kilometers). Some computerized maps allow users to zoom in or zoom out of a map surface, where a zoom level generally corresponds to a magnification of the viewing window that displays the map surface. Unlike a paper map that displays all map surface data in one fixed rendering, computer mapping applications may only display certain map features at a certain zoom level or magnification while excluding other map features. In these computer mapping applications, increasing a zoom level of a viewing window may not only enlarge features already displayed on a map, but may also cause the mapping application to draw additional features of the map. The number of map features displayed for a given magnification may be referred to herein as a density of map features. The density of map features and magnification may be specific to a zoom level.

While a map database may contain an enormous amount of map data for use in rendering a digital map, only a small fraction of the map data may be useful to a digital map user for any given mapping session. In particular, viewing of a digital map often requires a certain level of map detail, which may be based on a density of map features shown as well as a magnification. As discussed above, the density of map features and the magnification or scale of a map may be defined by a zoom level. Accordingly, a map user may need to view a map surface at a certain zoom level to be meaningful and useful. More particularly, while the zoom level may be adjusted so that any size area may be displayed to a user within a device screen, only certain zoom levels may be useful to a user for a particular user task or context. For example, at a sufficiently low zoom level, the entire United States may fit on any display device screen, but the details of a city like Chicago at such a low zoom level may be insufficient for a map user. Thus, the need to view a map at a particular zoom level may limit the amount of map area that can be displayed at any one time. Furthermore, a viewing window is generally limited in size by the physical limitations of the display device rendering the viewing window. The result of these limitations is that a given viewing window can only show a fraction of a meaningful map area at any one time.

By setting the appropriate viewing window position, viewing boundaries (or size), and zoom level, the viewing window may define a displayable portion of a map surface. In particular, the position of the viewing window may be centered about a center of the first map area, the size of the viewing window may define a set of boundaries of the displayed first map area, and the size of the first map area may be determined by the zoom level or magnification at which the displayed first map area is rendered. In an embodiment, the size of the viewing window may be fixed (e.g., limited by the physical size of a display device screen) while a magnification and position of the viewing window may be adjusted by a user.

In an embodiment, the block 402 may determine the viewing window by receiving an input from a user of a computer device. For example, the user may input a particular longitude, latitude, and altitude, as well as a zoom level. The size may be fixed by the display device or a program of the display device. In some embodiments, the determination of the viewing window may be made based on a pre-determined set of parameters for an initial rendering of a map location (e.g., a default location or area) or may be based on pre-stored settings that are in turn based on user preferences or a user profile. In another example, the determination may be made in response to a user input that initiates, for example, a pan action (e.g., a selection of an arrow indicating a pan in a particular direction, a swipe, etc.), a selection of a map feature or map point (e.g., via a touch screen press, a mouse click, etc.), etc. The block 404 may display a first area of the map surface in response to the received user input.

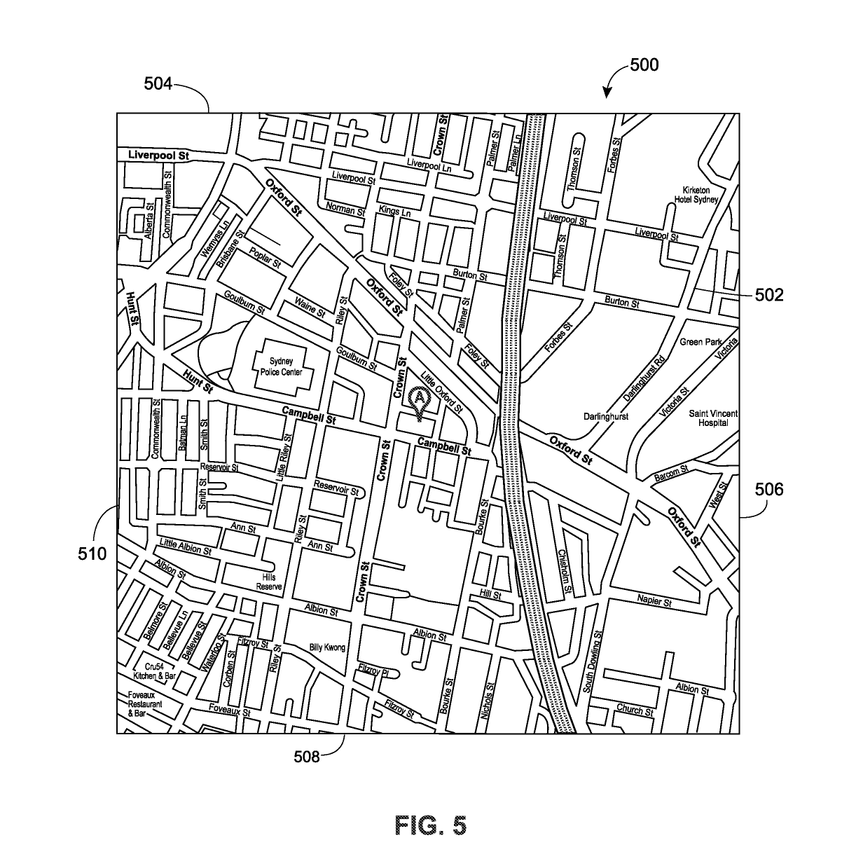

FIG. 5 illustrates a first or primary viewing window 500 of a first map surface. The primary viewing window 500 may generally show a portion of a map surface, or a first map area 502, that the user initiates a mapping session with, where a map session refers to a period of interaction of the user with the map application. The primary viewing window 500 may be defined by a set of borders 504-510 that correspond to the size of the primary viewing window 500 and define the first map area 502. While the borders 504-510 of the viewing window illustrated in FIG. 5 form a rectangular viewing window (with a corresponding rectangular first map area), it should be noted that other shapes of viewing windows may be implemented such as a circular or an elliptical shape and remain within the scope of the described device and system.

The block 406 may receive a user context that may be used in the block 408 to generate an OOV indicator. Generally, the user context may include a selection of an in-view map feature or a search for a map feature. A map feature may include any element of a map surface such as a road, a point location, an area, a building, etc. The block 406 may receive a selection of an in-view map feature in a number of manners known in the art. For example, a user may use a pointer device such as a mouse and direct a displayed pointer over the in-view map feature using the pointer device and click or select the in-view map feature. In an embodiment, the user may select a map feature by using the pointer device to hover a pointer over a map feature (without necessary clicking on the map feature).

The user context may also include a search for a map feature that may include a location, an area, a road, or other map feature. The user context may include a result of a search or may include parameters that may be used to initiate a search. In a situation where the user context includes the parameters for a search, the block 406 may be configured to initiate the search (e.g., execute a function to search) based on the search parameters to generate a search result(s). The search result(s) for a map feature may be a single map feature or a plurality of map features. If the search is for a type of map feature, such as a search for restaurants, a plurality of map features may result.

The user context may include a search that is performed after rendering or displaying an initial viewing window (e.g., after the block 404 is initiated). The search parameters may be based on the information displayed in the initial viewing window. For example, after viewing the initial viewing window, a user may initiate a search for a map feature(s) that is prompted by what the user sees in the initial viewing window. In an embodiment, a search may be performed before the initial viewing window is rendered (e.g., before the block 404 is initiated). This may be the case in which a map session begins with a user initiated search before any viewing window is displayed.

The block 408 may be configured to generate an OOV indicator based on the user context. Generally, an OOV indicator may be used to address some of the problems of trying to fit relevant map features into a limited viewing window by providing high level details (e.g., a label and a direction) of an OOV map feature. The OOV indicator may be useful in showing relationships between one or more features of a map. The OOV indicator may also provide functionality for retrieving additional information on the OOV map feature (to be discussed further below).

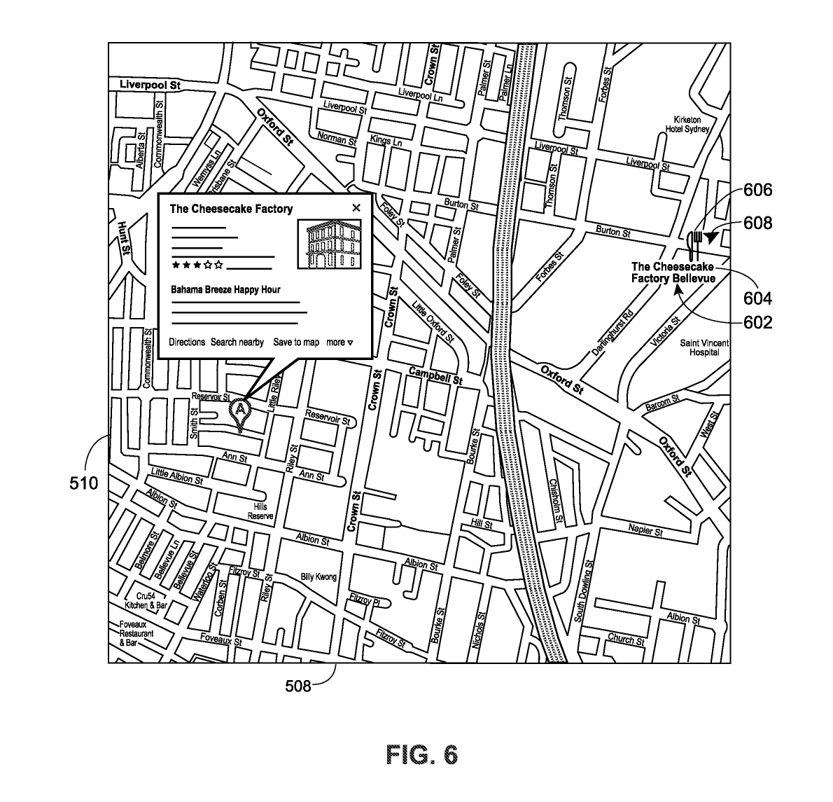

FIG. 6 illustrates a basic OOV indicator 602. The basic OOV indicator of FIG. 6 comprises a simple label 604, an icon 606, and an arrow 608. A basic OOV indicator may include a representation of the OOV map feature and a directional indicator to the OOV map feature. The representation may be a symbol and/or label (e.g., text label) identifying the OOV map feature. In an embodiment, the OOV indicator 602 may combine a symbol representing the OOV with a directional indicator. For example, a colored arrow may be used to designate an OOV feature such as a restaurant that is in a particular direction from the viewing window. Of course, shading, size, shape, etc. of a pointer or an arrow may be used in place of or in addition to the color based distinctions and remain within the scope of the claimed method and system. Combining the indicators may be convenient in situations where nomenclature is known or where a map legend is available for translating features of the map.

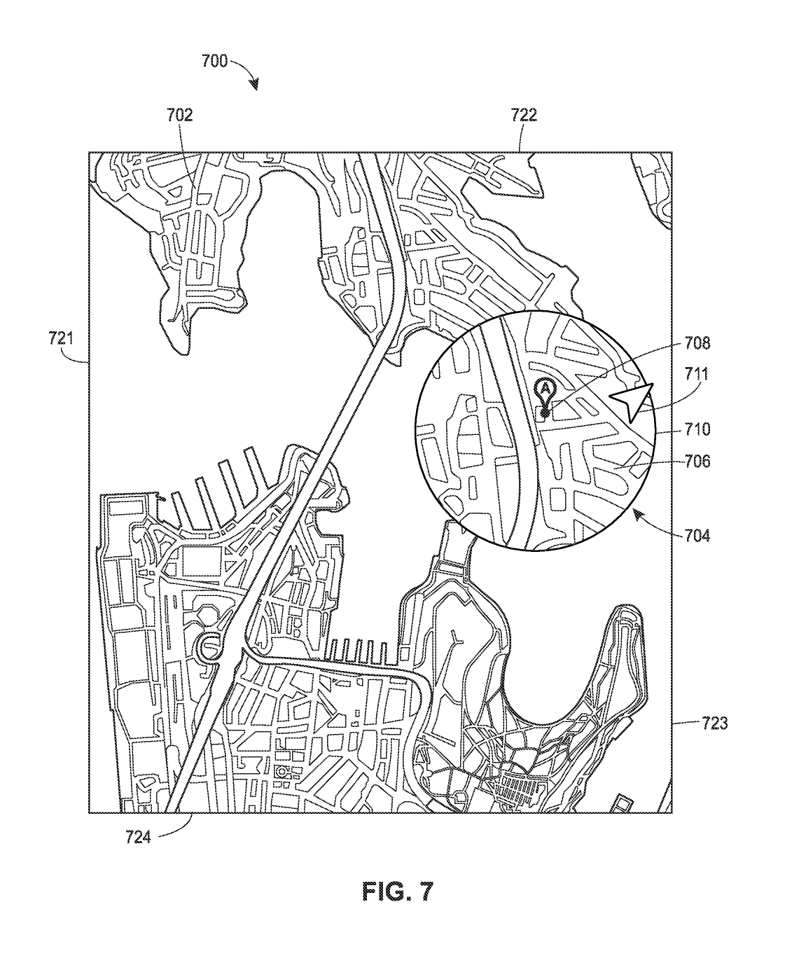

The block 410 may display the out-of-view indicator within a viewing window. FIG. 7 illustrates a viewing window 700 of a similar first map area 702 to that of FIG. 5 but with an addition of an OOV map indicator 704 that shows a second map area 706 about an external map feature 708. In the map of FIG. 7, the out-of-view map feature 708 is not contained in the first map area 702 defined by the borders 721-724 of the primary viewing window 700. The out-of-view map indicator 704 includes a second viewing window 710 of the second map area 706 about the out-of-view map feature 708. The OOV indicator 704 may be referred to herein as a “map within a map” OOV indicator, wherein the primary viewing window 700 displays a representation of the first map area 702 and the OOV indicator 704 includes a representation of the second map area 706 that is nested within the first viewing window 700. While the second viewing window 710 is contained within the primary viewing window 700, it is important to note that the second map area 706 is not contiguous with the first map area 702 even though the second map area 706 may be displayed over, within, or beside the first viewing window 700.

The map within a map OOV indicator 704 of FIG. 7 may include a number of display parameters that may be adjusted. Generally, the block 410 may display the second viewing window 710 with a smaller size than the primary viewing window 700 to emphasize that the OOV map feature 708 is an ancillary feature compared to the first map area 702 of the primary viewing window 700. For example, the second viewing window 710 may be limited to a diameter that is smaller than the primary viewing window 700. In an embodiment, the zoom level and corresponding magnification of the second viewing window 710 may be higher than the zoom level of the primary viewing window 700. This may be useful when the user needs to only ascertain the immediate surroundings of the OOV map feature 708. In an embodiment, the zoom level of the second viewing window 710 may be less than that of the primary viewing window 700. This may be useful when the user needs more directional references to better understand the location of the OOV map feature 708. For example, the second viewing window 710 may have a low enough zoom level so that it includes at least a portion of the first map area 702 defined by the first viewing window 700. The zoom level of the second viewing window 710 may be adjusted or determined based on data including a the user context, a user profile or priority or type of the OOV map feature 708.

In an embodiment, the density of map feature data for the second viewing window may be adjusted. As discussed above, the density of map feature data may also correspond with zoom level, where certain zoom levels may provide higher density map feature data for a given magnification. In an embodiment, the block 408 may generate the second viewing window with only a portion of a total amount of map feature data available for the zoom level. The block 408 may remove or add certain types of features based on a user or application setting. The modification of feature data for the second viewing window may be useful in reducing clutter and in improving the readability of the map of the second viewing window.

In an embodiment, the block 410 may generate the second viewing window 710 to include or not include certain map features that are in a vicinity of the OOV map feature 708. For example, the map features may include landmarks that are helpful in identifying the location of the OOV map feature 708. Some map features normally included with a map but do not provide useful information may be removed from the second map area 706 to reduce clutter and improve the visual aesthetic of the second viewing window 710.

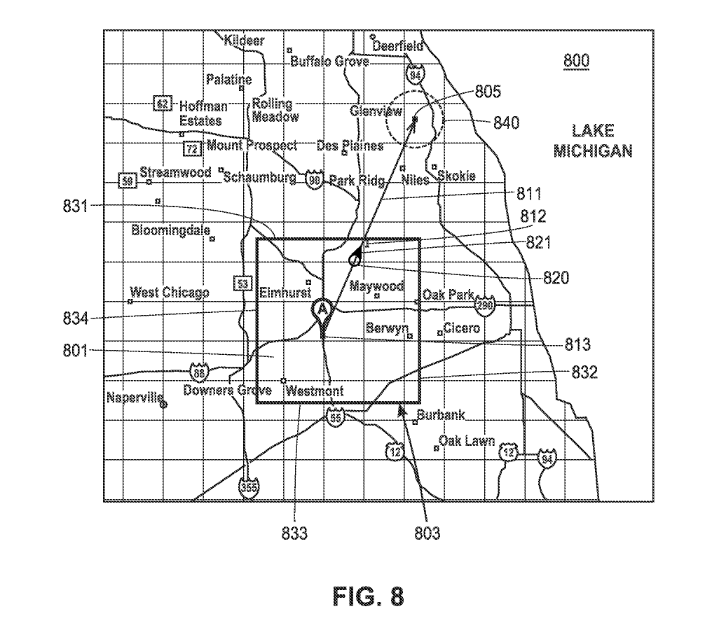

In an embodiment, the OOV indicator may be rendered along a vector originating from the center of the primary viewing window and directed toward the OOV map feature. FIG. 8 illustrates a map surface 800 in which only a first portion representing a first area 801 is rendered in a primary viewing window 803. An OOV map feature 805 is illustrated on the map surface 800 at a location external to the first area 801. FIG. 8 illustrates a line 811 or vector from a center 813 of the first area 801, or the center of the primary viewing window 803, to the location of the OOV map feature 805. In an embodiment, an OOV indicator 820 may be positioned about an intersection of the vector 811 and one of the viewing boundaries 831-834 of the primary viewing window 803. In FIG. 8, the intersecting boundary is boundary 831. In an embodiment, the OOV indicator 820 may be positioned on the vector 811 at an offset 812 from the boundary 831. The offset 812 may be fixed or may be adjusted based on other factors such as zoom level. In an embodiment, the OOV indicator 820 may include a directional indicator 821 such as a pointer or an arrow aligned in the direction of the OOV map feature 805 or otherwise aligned with the vector 811. In an embodiment in which the OOV indicator is a map within a map indicator such as that of FIG. 7, the block 408 may generate a second viewing window of an area 840.

After an initial rendering of an OOV indicator, a user may adjust the viewing window to change a position (i.e., panning) or a zoom level of the viewing window. In an embodiment, the block 408 may regenerate the OOV indicator and the block 410 may re-render the OOV indicator based on the change in the viewing window. For example, panning the viewing window may cause the block 410 to modify the placement and/or rotation of the OOV indicator where the OOV indicator is positioned based on the vector discussed above.

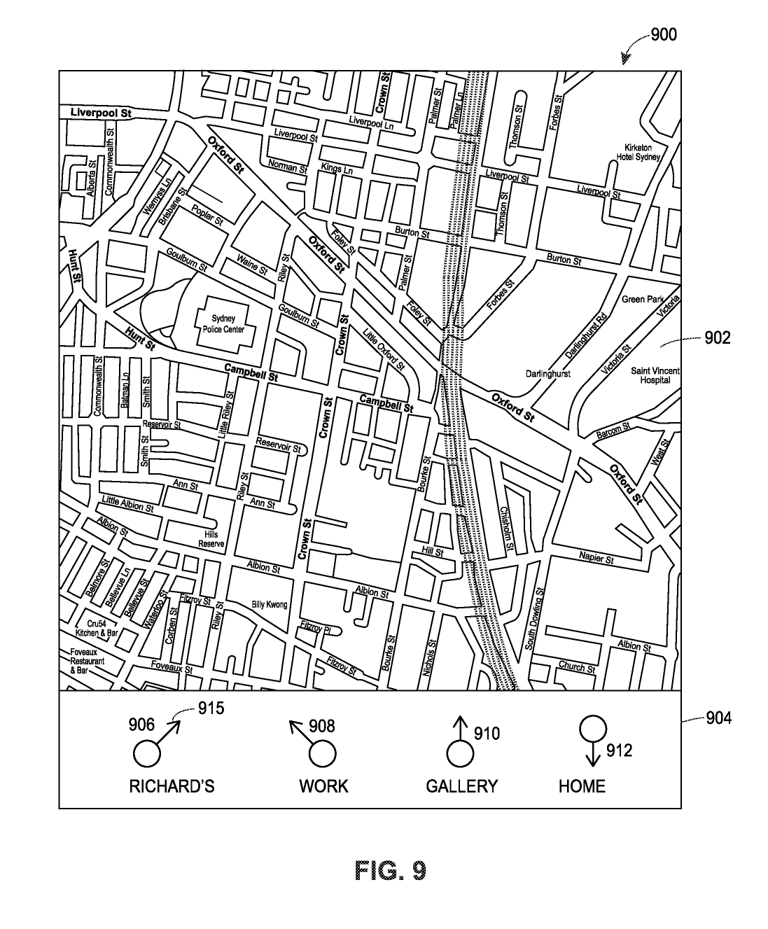

In an embodiment, the mapping application may partition the primary viewing window so that a portion of the primary viewing window is designated for rendering one or more OOV indicators. This designated OOV section may be used in lieu of or in addition to placing an OOV indicator along the vector from the viewing window position (e.g., center) to the OOV map feature as described above. In an embodiment, the OOV indicator section may be used to display any and all OOV indicators for the viewing window. FIG. 9 illustrates a primary viewing window 900 of a map area 902. Positioned at the bottom of the viewing window 900 is a designated OOV display section 904 where four OOV indicators 906-912 are displayed. In an embodiment, the OOV indicator may still include a directional indicator 915 or pointer that points from a viewing window position to a corresponding OOV map feature.

The block 410 may display the out-of-view indicator within the first viewing window based on a type of OOV indicator. In an embodiment, the block may be configured to position the OOV indicator along the vector from the viewing window (center) to the OOV map feature or in the designated OOV indicator area based on the priority of directional information. For example, in situations in which direction is important, the vector placement may be used so that a user may obtain a better sense of direction to the OOV map feature. In situations in which the existence or the identification of an OOV map feature is more important than direction, the designated area may be used.

For a given viewing window (as defined by at least viewing window position, size, and zoom level), certain map features may only be partially displayed in a current viewing window. In this situation, a user may desire to view additional information about the partially displayed map features, however a highly detailed OOV indicator may be overkill The block 410 may display or render a simplified OOV indicator to provide some details of the partial OOV map feature. While the user may pan (i.e., adjust the position of the viewing window) the viewing window to display more or all of a partially displayed map feature, a less complicated OOV indicator may be used to show cursory information of the partially shown OOV map feature. The cursory information on the partially out-of-view map feature may be enough for a user to forego the need to pan towards the out-of-view map feature, thereby saving time and effort.

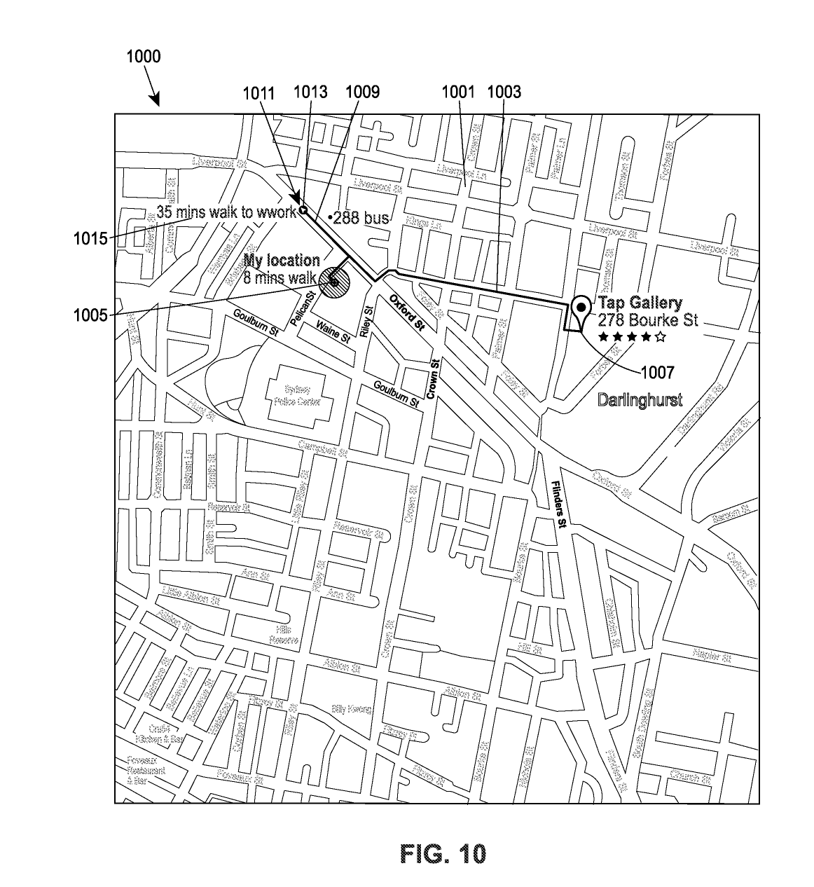

A particular situation in which partially out-of-view map features may need indicators is when a mapping application plots a route that does not entirely fit within a current viewing window (at a particular zoom level). FIG. 10 illustrates a viewing window 1000 of a map area 1001 that highlights a plurality of routes and includes an OOV to a partially in-view map feature. A first route 1003 includes a current user location 1005 as an origin and a destination location 1007 labeled as “Tap Gallery.” A second route 1009 is partially shown and includes an OOV indicator 1011 that comprises a directional pointer 1013 and a label 1015 indicating that the route's destination is a user's place of work. The OOV indicator may indicate that the second route 1009 continues off screen. In the situation of a partially in-view map feature such as a route, the block 408 may be configured to position the directional indicator 1013 such that it points to the destination of the route or to a subsequent segment of the route.

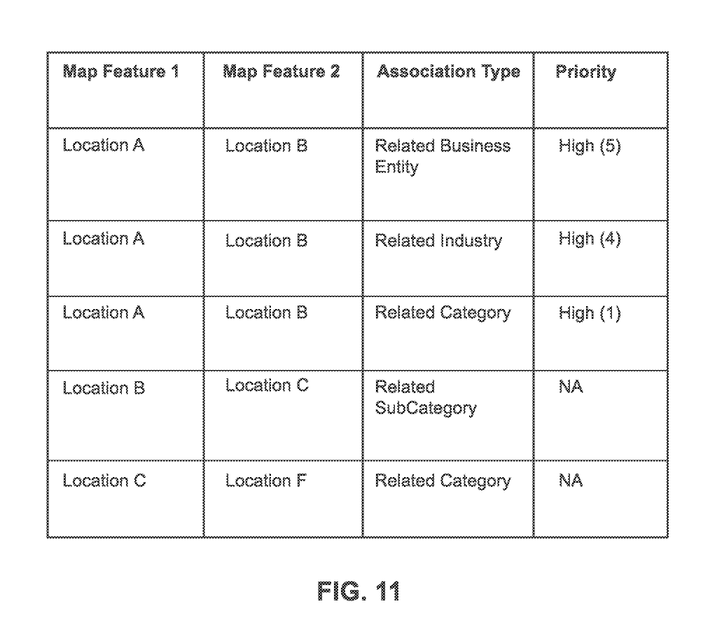

The user context received in the block 406 may be used to determine which OOV map features to generate OOV indicators of. As discussed above, the block 408 may generate the OOV indicator based on a selection of a map feature or a search for one or more map features. When the user context includes a selection of an in-view map feature, the block 408 may determine associations of the in-view map feature with other map features that may be important to the user. In an embodiment, the out-of-view map feature may be a map feature that corresponds with, is related to, or is otherwise associated with a selected feature of the first map area. FIG. 11 illustrates a data diagram of an association between two or more map features, a type of association, and a priority. FIG. 11 is illustrative only and one skilled in the art will understand that the data associations may be implemented in a number of ways such as tables and data pointers. FIG. 11 illustrates that a pair of map features may be associated with one another and the association may be categorized and prioritized by assigning a type and a priority identifier, respectively, to the pair of map features. In an embodiment, a pair of map features may have a plurality of relationships, each relationship represented by a row of the data diagram of FIG. 11, where each row or relationship also includes a category and a priority.

Generally, when the received user context is a selection of an in-view map feature, the block 406 may perform a search for map features that are associated with the selected map feature. The block 406 may use the data diagram of FIG. 11 (e.g., implemented as a database table) to determine the associations as well as a priority or a type of association of the related map features. The block 408 may then generate an OOV indicator based on one or more of the priority of the association or the association type. In a further embodiment, the block 408 may also consider a type of the related map feature when generating the OOV. For example, the OOV indicator may be different for buildings than it is for parks or roads. In an embodiment, an OOV indicator may be generated for a selected in-view map feature when the priority of the association between the in-view map feature and the OOV map feature is above a threshold priority. In an embodiment, the OOV indicator may be generated when a particular association type is encountered. For example, the block 408 may be configured to generate an OOV indicator whenever a map feature is found that is a related business entity to the selected map feature. Association types or categories may also have an inherent ranking or priority. Because the data diagram of FIG. 11 links both a priority and an association type to the pair of related map features, the priority value can be used to rank both the association (i.e., the pair of related map features) and the association category (i.e., the category assigned to the related pair). In an embodiment, an OOV indicator may be generated for a selected in-view map feature when a priority of an association or an association type is above a threshold priority. For example, if an in-view map feature corresponding to a corporation's headquarter is selected, the block 406 may obtain search results for related map features that include a plurality of subsidiary buildings that are located across a country. The block 408 may be configured to only generate an OOV indicator of a subsidiary building whose relationship with the corporation's headquarter has a priority that is higher than a threshold.

The user context received at the block 406 may be a search for a set of map features, such as a category of map features. If the result of the search is a single map feature, the block 408 may generate an OOV indicator of the single map feature and the block 410 may display the OOV indicator. If the result of the search is a plurality of map features, the block 408 may determine which one or more of the search results to generate an OOV indicator of. The block 410 may be configured to only display a single OOV indicator. In this case, the block 408 may determine the single OOV map feature from the plurality of search results based on a priority of the resulting map features. As discussed above, a search result may be generated by a function of the mapping application and in some embodiments, the block 406 may initiate a search based on received search parameters. The block 406 may order or rank the search results by relevancy to the search parameters (e.g., relevancy to a set of search terms comprising the search parameters) and the block 408 may generate an OOV indicator of the highest ranked (highest relevancy) result of the search result.

In an embodiment, the block 408 may be configured to generate a plurality of OOV indicators. In this embodiment, the block 408 may still select map features based on a priority of the search results. The block 408 may generate OOV indicators of the top ranked map features until a threshold is reached. For example, where the block 408 may be configured to generate no more than three OOV indicators, the block 408 may generate OOV indicators of the top three ranked search results. In an embodiment, the number of top ranked results used to generate OOV indicators may be limited by the size of the designated area for the OOV indicators. Alternatively, the block 408 may be configured to generate OOV indicators if the priority of the search result is above a threshold priority. The block 408 may adjust the threshold priority to generate more or less indicators based on a user setting of the map application or based on a monitored or determined current processor capacity or current bandwidth of a connection to a map server. For example, the block 408 may produce more OOV indicators when the current processor capacity or current bandwidth of a connection to a map server is above a threshold. When the current processor capacity or current bandwidth of a connection to a map server is below a threshold, the block 408 may produce less OOV indicators or none at all.

The block 406 may rank or prioritize the search results in a number of manners. As discussed above, a user context search may provide a default ranking of the results based on relevancy to a set of search parameters. Alternatively or in conjunction with relevancy to the search terms, the search results may be prioritized based on user profile data. User profile data may include a set of parameters that identify user preferences during a map session. The user profile data may include at least a user location or a set of locations. The user profile may also indicate an area of interest to the user. In an embodiment, the search results may be ranked based on a proximity of a search result to one or more of the user locations or areas included in the user profile. The search results that are closer to one or more of these locations may be ranked higher than search results further from the locations. The search results may be ranked by other data as well.

The block 408 may generate different types of OOV indicators based on the user context. In an embodiment, the block 408 may generate an OOV indicator based on any of the parameters of the data diagram of FIG. 11. The block 408 may generate one or more types of OOV indicators (such as the ones described above) based on priority, type of association, type of OOV map feature, etc. Moreover, the block 408 may generate one or more types of OOV indicators based on the priority ranking of the search results. In an embodiment, the block 408 may change a size of the OOV indicator to accommodate for additional detail or information. The size of the OOV indicator may be increased based on a priority of the OOV map feature. The block 408 may generate larger OOV indicators for higher priority OOV map features.

Generally, the amount of data required to generate an OOV indicator may be proportional to the complexity or level of detail of the type of OOV indicator being generated. For example, the map within a map OOV indicator of FIG. 7 may generally provide greater detail than the basic OOV indicator of FIG. 6. The level of detail of an OOV indicator may be adjustable. More complex and more detailed OOV indicators may be built by supplementing or modifying one or both of the representation (symbol/label) of the OOV map feature and the directional indicator to the OOV map feature that comprise the basic OOV indicator. More complex OOV indicators may be generated by modifying the type and level of details of the basic OOV indicator described above. For example, in the OOV indicator 704 of FIG. 7, the representation of the OOV map feature 708 is a map within a map and the directional indicator 711 is a pointer along a vector to the OOV map feature 708. The map within a map OOV indicator may also be considered a directional indicator that provides additional information about the location of the OOV map feature. The level of information displayed via the out-of-view indicator may reduce the time a user spends searching for information or navigating the digital map.

In an embodiment, the block 408 may index the types of OOV indicators by the amount of data required to generate the OOV indicators, where more complicated and more detailed OOV indicators (such as the map within a map OOV indicator of FIG. 7) require more data to generate than the basic OOV indicator of FIG. 6. The block 408 may then determine the type of OOV indicator to generate based on a current monitored processor capacity or a bandwidth of a communication link to a map server that provides the data for generating at least a portion of the OOV indicator. In an embodiment, the block 408 may generate more complicated OOV indicators that require a larger amount of data when the processor capacity or bandwidth is above a threshold and vice versa. Where the size of the OOV indicator is proportional to the amount of data required to render the OOV indicator, the size of the OOV indicator may be adjusted based on a response time for receiving the amount of data over the communication link at a current bandwidth or rate of data transfer. The block 408 may generate a specific size OOV indicator based on a threshold response time. For example, where a threshold response time is 400 milliseconds, the block 408 may be configured to generate a OOV indicator having a size that correspond with an amount of data that can be transferred over the communication link in less than 400 milliseconds.

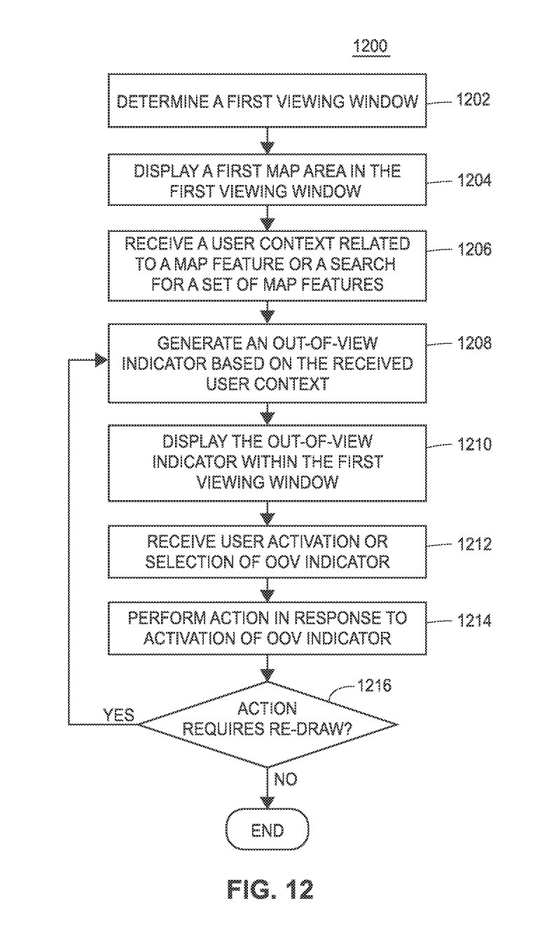

In an embodiment, the OOV indicator may be configured to be selectable or capable of being activated. FIG. 12 illustrates a process flow diagram or flow chart of a method, routine, or process 1200 that may be used to render an out-of-view indictor with operational functionality, according to an embodiment. Generally blocks 1202-1210 are similar to blocks 402-410 of FIG. 4. The process of FIG. 12 includes an additional process block 1212 for receiving a user selection or user activation of the OOV indicator. In response to receiving the user selection at the block 1212, a block 1214 may perform one or more actions or tasks based on the received selection of the block 1212. In an embodiment, the block 1214 may automatically pan the viewing window towards the OOV map feature. For example, the primary viewing window may be automatically centered about the OOV map feature corresponding to the selected OOV indicator. In this situation, the block 1214 may also remove the OOV indicator from the display as the OOV map feature will already be displayed in the first map area of the primary viewing window.

In an embodiment, a block 1216 may determine whether the activation of the OOV indicator requires a regeneration or redrawing of the OOV indicator. For example, the block 1216 may direct the process 1200 back to the block 1208 to re-generate the OOV indicator to provide more or less data. In an embodiment, the block 1208 may generate the OOV indicator as an operational item that, when activated or selected, can provide additional options, such as a menu or action buttons, and additional information. For example, in an embodiment, clicking the OOV indicator (block 1212) may bring up additional menu screens (via the blocks 1214, 1216, 1208, and 1210) for generating and displaying additional information on the OOV map feature. In an embodiment, the type of OOV indicator may be modified when the OOV indicator is clicked or selected (the block 1212), wherein each selection prompts the generation and display of a more complex and more information-rich OOV indicator type.

Generally, information on an out-of-view map feature may be obtained by panning (or reposition) the viewing window about or towards the out-of-view map feature without using OOV indicators. However, panning may not provide any of the benefits of an OOV indicator as described herein. First, panning a viewing window requires a map user to be aware of the existence of the out-of-view map feature(s). Second, the user may need to apply additional work to re-position the viewing window to bring the out-of-view map features into view. Without a directional indicator, this may be difficult, even if the user knows of the existence of an OOV map feature of interest. Third, panning the viewing window may not eliminate the problem that map features brought into view may be done at the expense of losing sight of previous map features that are also important to the user or to a user context. Thus, panning requires additional work and occasionally, the need to memorize information in a current viewing window before the viewing window is panned and the previous information is no longer in view.

The OOV indicators described herein provide a user additional contextual information on OOV map features that are not shown in a current viewing window as defined by a given set of viewing window parameters (i.e., at least position, viewing boundaries, and zoom level). The out-of-view indicator alerts the user to the existence of an out-of-view map feature that may be relevant or important to a user context. The out-of-view indicator may indicate contextual information that the user may need to make decisions during an information search or a navigation task. For example, once the user is informed of the existence of an out-of-view map feature the user may decide to pan or adjust the current viewing window towards the out-of-view map feature. As discussed above, the OOV indicators may provide functional shortcuts to the OOV map feature (e.g., auto panning to the OOV map feature). Alternatively, the out-of-view indicator may provide the user enough information about the out-of-view map feature such that the user may forego additional map application usage (including the need to pan towards the out-of-view indicator). Thus, being made aware of such out-of-view map features via the described OOV indicators may potentially add greater context for users of mapping applications, thereby allowing them to fully understand the environment that they are currently viewing through the mapping application and be more efficient in their information search.

Any suitable subset of the blocks may be implemented in any suitable order by a number of different devices (e.g., client or server) and remain consistent with the method and system described herein. Moreover, additional determination blocks may be added to refine the filtering of style parameters subject to interpolation processing.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 25 may include but is not limited to any combination of a LAN, a MAN, a WAN, a mobile, a wired or wireless network, a private network, or a virtual private network. Moreover, while only four client devices are illustrated in FIG. 1 to simplify and clarify the description, it is understood that any number of client computers or display devices are supported and can be in communication with the server 14.

Additionally, certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map rendering system for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for rendering map or other types of images using the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer-implemented method of providing an out-of-view indicator to a computer device comprising:
determining, using a computer device, a first viewing window of a map surface, the first viewing window defined by a set of viewing parameters including a position, a set of viewing boundaries, and a magnification;
displaying, using the computer device, a first area of the map surface in the first viewing window based on the set of viewing parameters;
receiving, using the computer device, a user context associated with at least one of a user selected map feature or a search request for a set of map features;
generating, using the computer device, an out-of-view indicator of an out-of-view map feature based on the received user context, wherein the out-of-view map feature is external to the displayed first area of the map surface; and
displaying, using the computer device, the out-of-view indicator within the first viewing window over the first area, wherein the out-of-view indicator includes a directional indicator and includes a second viewing window displaying a second area of the map surface that contains the out-of-view map feature, wherein the first area and the second area are not contiguous and are not overlapping, and wherein the second area is relocated over a portion of the first area.

2. The computer-implemented method of claim 1, wherein generating the out-of-view indicator includes determining a vector from a center of the viewing window to the out-of-view map feature; and
wherein displaying the out-of-view indicator includes displaying the out-of-view indicator on the viewing window along the vector and offset from one of the set of boundaries of the viewing window.

3. The computer-implemented method of claim 1, wherein displaying the out-of-view indicator includes displaying the out-of-view indicator on the viewing window in a designated out-of-view indicator area of the first viewing window.

4. The computer-implemented method of claim 3, further including generating a second out-of-view indicator and displaying the first and the second out-of-view indicator in the designated out-of-view indicator area.

5. The computer-implemented method of claim 1, wherein a diameter of the out-of-view indicator is less than a diameter of the first viewing window.

6. The computer-implemented method of claim 1, wherein generating the out-of-view indicator includes determining a magnification for the second viewing window based on a priority of the out-of-view map feature and wherein the out-of-view indicator is rendered at a magnification that is different than the magnification of the first viewing window.

7. The computer-implemented method of claim 1, wherein generating the out-of-view indicator includes determining a set of map features to include in the second viewing window of the out-of-view indicator.

8. The computer-implemented method of claim 1, wherein a size of the out-of-view indicator is based on a priority of the out-of-view map feature.

9. The computer-implemented method of claim 1, wherein the first area includes a set of in-view map features that are displayed within the first viewing window and wherein the user context is a user selected one of the set of in-view map features.

10. The computer-implemented method of claim 1, further including performing a search of map features associated with the user context and prioritizing a result set of the search, wherein generating an out-of-view indicator includes generating an out-of-view indicator of a map feature of the result set that is above a threshold priority.

11. The computer-implemented method of claim 1, further including changing at least one of (i) the position of the viewing window or (ii) the magnification of the viewing window and re-generating the out-of-view indicator.

12. The computer-implemented method of claim 1, further including receiving a user-initiated activation of the out-of-view indicator and in response to receiving the activation, positioning the first viewing window about the out-of-view map feature.

13. The computer-implemented method of claim 1, further including receiving a user-initiated activation of the out-of-view indicator and in response to receiving the activation, modifying an amount of detail of the out-of-view indicator.

14. A computer device comprising:
a communications network interface;
one or more processors;
one or more memories coupled to the one or more processors;
a display device coupled to the one or more processors;
wherein the one or more memories include computer executable instructions stored therein that, when executed by the one or more processors, cause the one or more processors to
determine a first viewing window of a map surface, the first viewing window defined by a set of viewing parameters including a position, a set of viewing boundaries, and a magnification;
display a first area of the map surface in the viewing window based on the set of viewing parameters;
receive a user context associated with at least one of a user selected map feature or a search request for a set of map features;
generate an out-of-view indicator of an out-of-view map feature based on the received user context, wherein the out-of-view map feature is external to the displayed first area of the map surface; and
display the out-of-view indicator within the first viewing window over the first area, wherein the out-of-view indicator includes a directional indicator and includes a second viewing window displaying a second area of the map surface that contains the out-of-view map feature, wherein the first area and the second area are not contiguous and are not overlapping, and wherein the second area is relocated over a portion of the first area.

15. The computer device of claim 14, wherein generating the out-of-view indicator includes determining a vector from a center of the viewing window to the out-of-view map feature and wherein displaying the out-of-view indicator includes displaying the out-of-view indicator on the viewing window along the vector and offset from one of the set of boundaries of the viewing window.

16. The computer device of claim 14, wherein displaying the out-of-view indicator includes displaying the out-of-view indicator on the viewing window in a designated out-of-view indicator area of the first viewing window.

17. The computer device of claim 16, wherein the one or more memories include computer executable instructions stored therein that, when executed by the one or more processors, cause the one or more processors to generate a second out-of-view indicator and to display the first and the second out-of-view indicator in the designated out-of-view area.

18. The computer device of claim 14, wherein generating the out-of-view indicator includes determining a magnification for the second viewing window based on a priority of the out-of-view map feature and wherein the out-of-view indicator is rendered at a magnification that is different from the magnification of the first viewing window.

19. The computer device of claim 14, wherein generating the out-of-view indicator includes determining a set of map features to include in the second viewing window of the out-of-view indicator.

20. The computer device of claim 14, wherein the first area includes a set of in-view map features that are displayed within the first viewing window and wherein the user context is a user selected one of the set of in-view map features.

21. The computer device of claim 14, wherein the one or more memories include computer executable instructions stored therein that, when executed by the one or more processors, cause the one or more processors to initiate a search of map features associated with the user context and to prioritize a result set of the search, wherein generating the out-of-view indicator includes determining a map feature of the search result set that is above a threshold priority.

22. The computer device of claim 14, wherein the one or more memories include computer executable instructions stored therein that, when executed by the one or more processors, cause the one or more processors to receive a user-initiated activation of the out-of-view indicator and in response to receiving the activation, position the first viewing window about the out-of-view map feature.

23. The computer device of claim 14, wherein the one or more memories include computer executable instructions stored therein that, when executed by the one or more processors, cause the one or more processors to receive a user-initiated activation of the out-of-view indicator and in response to receiving the activation, modify an amount of details of the out-of-view indicator.

24. The computer device of claim 14, wherein generating the out-of-view indicator is based on a current bandwidth of a communication link of the communications network interface with a map database server, wherein the out-of-view indicator is generated when the current bandwidth of the communication link is above a threshold.

25. The computer device of claim 24, wherein generating the out-of-view indicator includes selecting a type of out-of-view indicator to generate based on the current bandwidth of the communication link.

26. The computer device of claim 25, wherein a size of the out-of-view indicator is determined based on the current bandwidth of the communication link and a threshold response time for receiving an amount of data required to render the out-of-view indicator.

27. A computer device comprising:
a communications network interface;
one or more processors;
one or more memories coupled to the one or more processors;
a display device coupled to the one or more processors;
wherein the one or more memories include computer executable instructions stored therein that, when executed by the one or more processors, cause the one or more processors to
determine a first viewing window of a map surface, the first viewing window defined by a set of viewing parameters including a position, a set of viewing boundaries, and a magnification;
display a first area of the map surface in the viewing window based on the set of viewing parameters;
receive a user context associated with at least one of a user selected map feature or a search request for a set of map features;
display the out-of-view indicator within the first viewing window, with a first set of details regarding the out-of-view map feature;
receive a user activation of the displayed out-of-view indicator; and
re-generate the out-of-view indicator with a second set of details regarding the out-of-view map feature based on the received activation, wherein the second set of details includes at least one of an additional option or an additional menu to obtain additional information regarding the out-of-view map feature.
